(19) United States
(12) Patent Application Publication
(10) Pub. No.: US 2013/0100803 A1
(43) Pub. Date: Apr. 25, 2013

(54) APPLICATION BASED BANDWIDTH CONTROL FOR COMMUNICATION NETWORKS

(71) Applicant: QUALCOMM INCORPORATED, San Diego, CA (US)

(72) Inventors: Benjamin M. MENCHACA, Austin, TX (US); Ryan A. NOWAKOWSKI, Austin, TX (US); Wayne G. DUNLAP, Austin, TX (US)

(73) Assignee: QUALCOMM INCORPORATED, San Diego, CA (US)

(21) Appl. No.: 13/656,602

(22) Filed: Oct. 19, 2012

Related U.S. Application Data
(60) Provisional application No. 61/550,339, filed on Oct. 21, 2011.

(51) Int. Cl. H04L 12/24

(52) U.S. Cl. 370/230

(57) ABSTRACT

A network traffic managing node of a local area network, such as a router or gateway, can implement a packet stream detection and application based bandwidth control for the local area network. A plurality of packet streams are received and detected at a network traffic managing node of a local area network. One or more applications associated with the plurality of packet streams are determined. Stream characterization parameters associated with each of the one or more applications associated with the plurality of packet streams are also determined. Application based bandwidth control is performed on the plurality of packet streams based, at least in part, on the stream characterization parameters associated with each of the applications.

### RELATED APPLICATIONS

This application claims the priority benefit of U.S. Provisional Application No. 61/550,339 filed Oct. 21, 2011.

### BACKGROUND

Embodiments of the inventive subject matter generally relate to the field of communication networks and, more particularly, to an application based bandwidth control mechanism for communication networks.

Local area networks (LANs), such as home or office networks, typically include a router (or gateway) that connects the LAN to a wide area network (WAN) and routes packets between the two networks. Various network devices in a LAN can access and download information from the Internet via a router. The router can manage the various uplink and downlink packet streams between the WAN and the LAN. The router can also provide various security features, such as a firewall, to prevent unauthorized or malicious attempts to remotely access the LAN.

### SUMMARY

Various embodiments are disclosed for implementing a packet stream detection and application based bandwidth control mechanism for a local area network. In one embodiment, a plurality of packet streams are received and detected at a network traffic managing node of a LAN having an available bandwidth. An application associated with each of the plurality of packet streams is determined. Stream characterization parameters associated with each application are also determined. A bandwidth is allocated for each of the plurality of packet streams based, at least in part, on the stream characterization parameters associated with each application. The sum of the bandwidth allocated for each of the plurality of packet streams does not exceed the available bandwidth.

### BRIEF DESCRIPTION OF THE DRAWINGS

The present embodiments may be better understood, and numerous objects, features, and advantages made apparent to those skilled in the art by referencing the accompanying drawings.

FIG. 1 is an example block diagram illustrating an application based bandwidth control mechanism for a communication network, according to some embodiments;

FIG. 2 is a flow diagram illustrating example operations for implementing the application based bandwidth control mechanism at a router of a local area network, according to some embodiments;

FIG. 3 is a continuation of the flow diagram of FIG. 2 illustrating additional example operations for implementing the application based bandwidth control mechanism at the router of the local area network, according to some embodiments;

FIG. 4 is a network diagram showing an example of various packet streams being routed and processed via the router of the local area network, according to some embodiments; and

FIG. 5 is a block diagram of one embodiment of a network device including a mechanism for application based bandwidth control in a local area network, according to some embodiments.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although some examples refer to a specific set of stream characterization parameters to perform the application based bandwidth control techniques described herein, in other examples various other parameters may be considered to perform application based bandwidth control. In other instances, well-known instruction instances, protocols, structures and techniques have not been shown in detail in order not to obfuscate the description.

Applications that are run by users of a local area network (LAN) typically compete for limited bandwidth on an Internet connection. For example, multiple applications being used by one or more users may compete for limited bandwidth available in a LAN via a router of a home or office network. Jitter, latency, and packet loss can increase as packets collide due to this competition for bandwidth. In response to the increased jitter, latency and packet loss, the performance of the applications and overall network can be degraded, which can impact the user experience.

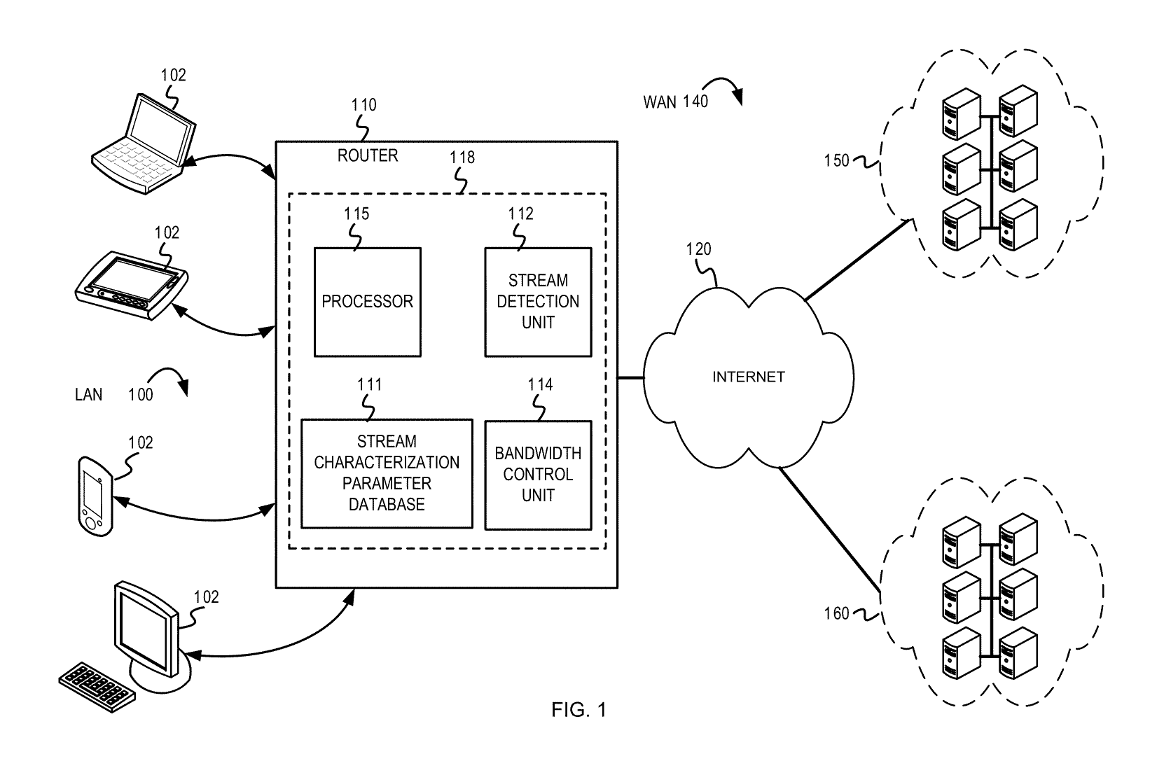

In some embodiments, a router (or gateway) in a LAN can implement application stream detection techniques to determine an application associated with each of the packet streams that are active at the router. The router can also determine stream characterization parameters for each of the packet streams associated with the detected applications. The router can then perform application based bandwidth control based, at least in part, on the stream characterization parameters associated with each of the active applications at the router, as will be further described below with reference to FIGS. 1-4.

FIG. 1 is a block diagram illustrating an exemplary application based bandwidth control mechanism for a communication network. As shown in FIG. 1, a LAN 100 comprises a plurality of network devices 102 and a router 110. The plurality of network devices 102 may include various type of wired and wireless networking devices, such as notebook computers, tablet computers, mobile phones, desktop computers, digital cameras, televisions, gaming consoles, smart appliances, and other suitable network devices. The router 110 (or gateway) may be a network traffic managing node between two or more networks that receives, processes, and routes packets associated with the networks. It is noted, however, that in other embodiments the LAN 100 may include other types of network traffic managing nodes that are configured to perform various functions for the network(s), e.g., a server computer system that incorporates one or more of a cable modem, gateway/router, wireless access point, bridge, switch and/or storage, which may also implements the functionality describe herein with reference to FIGS. 1-5. As shown in FIG. 1, the router 110 allows the network devices 102 of the LAN 100 to access the WAN 140 and receive content from the WAN 140. The LAN 100 may be one of many LANs that form the WAN 140, which may be generally referred to as the Internet 120. As illustrated, the WAN 140 may also include various networks of servers (and other network devices and software). In one example, one of the networks of servers can implement cloud computing on the Internet 120, which will be referenced herein as the cloud computing network 150 (or the cloud 150). In another example, a service provider 160 of Internet content (e.g., streaming video providers) may operate a network of servers to provide content over the Internet 120. The router 110 can route a plurality of packet streams that are associated with a plurality of different applications to and from the LAN 100. For example, the router 110 can route a packet stream associated with streaming video, a packet stream associated with streaming music, and a packet stream associated with a file download. In some embodiments, the router 110 is configured to implement an application based bandwidth control mechanism to improve the performance of each of the applications and the overall performance of the LAN 100, as will be further described below.

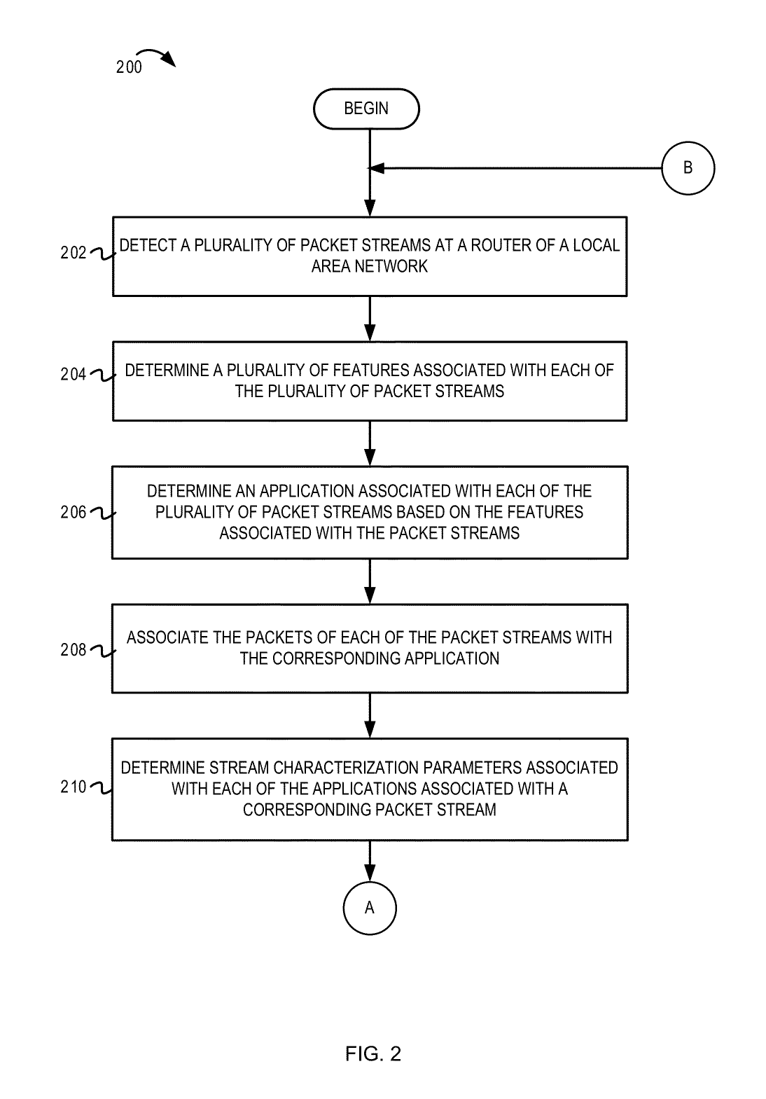

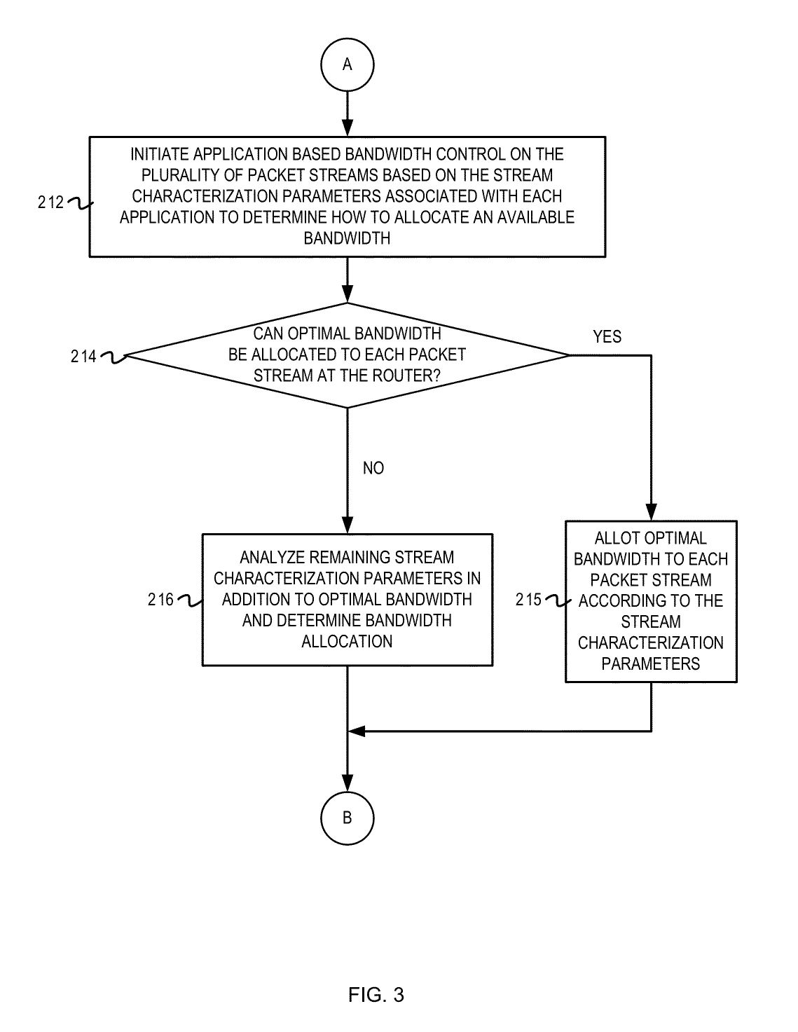

In some embodiments, as illustrated in FIG. 1, the router 110 may include a stream characterization parameter database 111, a stream detection unit 112, a bandwidth control unit 114, and a processor 115 to implement the application based bandwidth control mechanism described herein. In one implementation, the stream detection unit 112 analyzes the various packet streams being routed through the router 110 to detect a plurality of features of the packet streams. The stream detection unit 112 then determines the specific application associated with the packet stream based on the packet stream features (e.g., packet header information), as will be further described below with reference to FIGS. 2-3. The stream characterization parameter database 111 may be a database that stores stream characterization parameters for a plurality of applications that can be detected at the router 110. For example, the router 110 can be preconfigured with stream characterization parameters for the top 100 most common applications that are used in web-based communication networks. The stream characterization parameters for each application may include a jitter tolerance value, a minimum bandwidth, an optimal bandwidth, a maximum bandwidth, and/or a priority value. The stream characterization parameters for the different applications can be determined based on automated tests or manual lab tests performed on packet streams for various applications that are commonly used in web-based communication networks. For example, stream characterization parameters may be determined for video streaming services such as Netflix®, Hulu®, and YouTube®, music streaming services such as Pandora®, file download and storage services such as iTunes® and Amazon®, online gaming services, and various others. The bandwidth control unit 114 can determine the stream characterization parameters associated with the packet streams based on the specific application associated with each packet stream. The bandwidth control unit 114 can perform application based bandwidth control using the stream characterization parameters to determine how to best allocate the available bandwidth to the various packet streams being routed through the router 110, as will be further described below with reference to FIGS. 2-3.

As shown in FIG. 1, in some implementations, the router 110 may include a network interface card (or module) 118. The network interface card 118 may implement the stream characterization parameter database 111, the stream detection unit 112, the bandwidth control unit 114, and the processor 115 (e.g., in one or more integrated circuits). In other implementations, the router 110 may include a plurality of network interface cards and circuit boards (including network interface card 118), and the plurality of network interface cards may implement the stream characterization parameter database 111, the stream detection unit 112, the bandwidth control unit 114, and the processor 115. Although not shown in FIG. 1, in some implementations, the router 110 may include one or more additional processors (besides processor 115) and memory units (and other components). In some embodiments, the processor 115 of the router 110 can execute program instructions associated with the stream detection unit 112 to implement the application stream detection techniques described herein. Also, in some embodiments, the processor 115 can execute program instructions associated with the bandwidth control unit 114 to implement the application based bandwidth control techniques described herein.

FIG. 2 and FIG. 3 are flow diagrams (“flows”) illustrating example operations 200 for implementing the application based bandwidth control mechanism at a router of a local area network, according to some embodiments. The flow begins at block 202 of FIG. 2 and continues with block 212 of FIG. 3.

At block 202, a plurality of packet streams are detected at the router of the local area network. In some implementations, the stream detection unit 112 of the router 110 detects the plurality of packet streams associated with the LAN 100 and initiates application stream detection operations at the router 110. For example, the stream detection unit 112 detects uplink packet streams from the network devices 102 of the LAN 100 to the WAN 140 via the router 110, and downlink packet streams from the WAN 140 to the LAN 100 via the router 110. After block 202, the flow continues at block 204.

At block 204, a plurality of features associated with each of the plurality of packet streams are determined. In some implementations, the stream detection unit 112 inspects the packets of each of the plurality of packet streams (e.g., performs deep packet inspection) to determine the plurality of features associated with each of the packet streams. For example, the stream detection unit 112 can inspect the protocol headers of each of the packets, and analyze the byte distribution, packet size, inter-frame gap distributions and other suitable packet stream features. The stream detection unit 112 can also analyze the distribution of packet sizes in both uplink and downlink directions associated with a packet stream, the ratio of sent to received packets associated with a packet stream, and other such packet stream features. The stream detection unit 112 performs this analysis on both uplink and downlink packet streams that are detected at the router 110. The plurality of features associated with each packet stream can determine the packet stream signature or fingerprint, which can be used to identify the application associated with each packet stream. It is noted that various combinations of features associated with a packet stream can determine the packet stream signature, and the number and the type of features that form the packet stream signature can be customizable or configurable. After block 204, the flow continues at block 206.

At block 206, an application associated with each of the plurality of packet streams is determined based on the features associated with the packet streams. In some implementations, the stream detection unit 112 determines a specific application associated with each of the plurality of packet streams based on the packet stream signature (or packet stream fingerprint). As described above in block 204, the plurality of features associated with each packet stream can determine the packet stream signature for the packet stream. In some implementations, the stream detection unit 112 can compare the packet stream signature of each packet stream with a plurality of predefined packet stream signatures associated with a plurality of known applications. In other words, the stream detection unit 112 can compare the plurality of features associated with each packet stream with the predefined packet stream signatures of the known applications. The stream detection unit 112 can determine that an application is associated with a packet stream when the packet stream signature associated with the application matches the packet stream signature associated with the packet stream. In one implementation, the stream detection unit 112 detects a match if the packet stream signatures match within a predefined confidence level. In one example, the predefined confidence level may be 90%. In another example, the predefined confidence level may be 95%. It is noted, however, that the predefined confidence level may be other suitable values and the confidence level may be customizable or configurable.

The router 110 may store the known packet stream signatures associated with various known applications (and the corresponding web-based services). In one implementation, the router 110 may store and manage a mapping between the known packet stream signatures and the corresponding application. For example, the router 110 may store packet stream signatures for a YouTube video streaming application, a Pandora music streaming application, a bit torrent file download application, and various other known applications (e.g., Hulu, iTunes, etc.). The router 110 may be preconfigured with the packet stream signatures of a plurality of known applications. The router 110 can also be configured by a network administrator with new packet stream signatures or the network administrator can update (or trigger an update of) existing packet stream signatures. Also, the router 110 can be automatically updated and configured via the Internet by the application/service providers or by a cloud-based computing network managed by the manufacturer/developer of the router 110. After block 206, the flow continues at block 208.

At block 208, the packets of each of the packet streams are associated with the corresponding application. In some implementations, the stream detection unit 112 tags or classifies each of the packets of the packet streams to indicate the packets are associated with a particular application. For example, each of the packets of the YouTube video streaming application are tagged to indicate each packet is associated with the YouTube video streaming application. In some implementations, the packets of each packet stream may be tagged based on multiple fields in the packet headers. For example, the 5-tuple information in the packet headers including the IP source address, IP destination address, TCP source port, TCP destination port, and protocol indicator can be associated with a particular application. As will be described further below, the tags associated with each packet can be used by the bandwidth control mechanism to determine the stream characterization parameters associated with each application stream and subsequently perform application based bandwidth control. It is noted, however, that in other implementations the packets can be associated with a particular application by other techniques.

In some implementations, if the stream detection unit 112 cannot determine a specific application associated with a packet stream being routed through the router 110 based on the features of the packet stream, the stream detection unit 112 may instead determine a packet stream type or category. For example, after determining the features associated with the packets of the packet stream, the stream detection unit 112 may determine that the packet stream features do not match any of the predefined packet stream signatures associated with the known applications. Even though the stream detection unit 112 may not be able to associate the packet stream with a specific application (e.g., Netflix application), the stream detection unit 112 may determine an application type or application category associated with the packet stream. For example, the stream detection unit 112 may determine the application type or application category associated with the packet stream based on the features associated the packet stream, and/or based on the packet header information (e.g., source address, protocol indicator, etc.). The stream detection unit 112 may determine the packet stream is network traffic associated with an application type or category, such as a video streaming application, a gaming application, an audio streaming application, a file download application, or other types or categories of applications. After determining the type or category of application associated with the packet stream, the stream detection unit 112 can tag or classify the packets to associate each of the packets of the packet stream with the application type or category. After block 208, the flow continues at block 210.

At block 210, stream characterization parameters associated with each of the applications associated with a corresponding packet stream are determined. In some implementations, the bandwidth control unit 114 of the router 110 determines the stream characterization parameters associated with each of the applications associated with each of the packet streams based on the information stored in the stream characterization parameter database 111. For example, based on the packet stream classification performed by the stream detection unit 112, the bandwidth control unit 114 can determine the specific application associated with each packet stream (e.g., a Netflix application). In one example, the bandwidth control unit 114 can detect the tag or classification information associated with each packet of the packet stream that indicates the specific application associated with the packet stream. The bandwidth control unit 114 can then read an entry in the stream characterization parameter database 111 that associates the specific application (e.g., the Netflix application) with specific stream characterization parameters. For example, stream characterization parameter database 111 can associate each specific application with at least a subset of the following stream characterization parameters: a jitter tolerance value, a minimum bandwidth, an optimal bandwidth, a maximum bandwidth, and a priority. As described above, the stream characterization parameters associated with each known application can be predefined and customized based on various lab tests and/or based on information provided by the application service provider or application developer. The jitter tolerance value can indicate the jitter tolerance of each application (e.g., low, intermediate, and high jitter tolerance). The minimum bandwidth can indicate the minimum amount of bandwidth that the application typically requires to operate and perform at some minimum/acceptable performance level. The optimal bandwidth can indicate the optimal amount of bandwidth that the application typically requires to operate and perform at an optimum performance level. In some implementations, the optimal bandwidth is a predefined or customized bandwidth level between the minimum and maximum bandwidths for each application that has been shown through various lab tests to result in optimum performance for the corresponding application in a network. For example, allocating a bandwidth greater than the predefined optimal bandwidth will typically not result in improved performance compared to allocating the predefined optimal bandwidth. The maximum bandwidth can indicate the maximum amount of bandwidth that the application may need from time to time (and typically for a limited amount of time). For example, if there are some stale packets or if the bandwidth has been reduced for an application during a period of time, the bandwidth may need to be increased beyond the optimal bandwidth level to send the stale packets or extra packets during a subsequent period of time in order to maintain on average the optimal bandwidth. The priority parameter may be another variable that the bandwidth control unit 114 may consider for application based bandwidth control, and it may indicate priority with respect to each application, or priority with respect to the type or category of application. For example, if a Netflix application has been detected, the packets associated with the Netflix application will be classified as video packets, which are generally assigned a higher quality of service (QoS) priority than file download packets (or other best effort traffic). In some implementations, the bandwidth control unit 114 can perform the same operation for all of the detected packet streams to determine the stream characterization parameters associated with each application associated with each of the packet streams detected at the router 110.

Also, as described above, if a packet stream is not associated with a specific application, but instead it is associated with a type or category of applications (e.g., a video streaming application), the bandwidth control unit 114 can determine default stream characterization parameters associated with the type or category of applications. In other words, in addition to the stream characterization parameter database 111 associating specific applications with stream characterization parameters, the database 111 can also associate application types or categories with default stream characterization parameters. For example, the video streaming application type may be associated with default stream characterization parameters for typical video streaming traffic, and the file download application type may be associated with default stream characterization parameters for typical file download/upload traffic. In some cases, if the application type or category associated with a packet stream cannot be determined, the bandwidth control unit 114 can associate the packet stream with default minimum (or “best efforts”) stream characterization parameters. After block 210, the flow continues at block 212 of FIG. 3.

At block 212 of FIG. 3, application based bandwidth control is initiated on the plurality of packet streams based on the stream characterization parameters associated with each application to determine how to allocate an available bandwidth at the LAN. In some implementations, the bandwidth control unit 114 of the router 110 can perform application based bandwidth control to allocate at least part of the available bandwidth among the active applications with router traffic to and from the WAN 140 to attempt to provide users of the LAN 100 optimal overall network performance without exceeding the available bandwidth. For example, the bandwidth control unit 114 performs application based bandwidth control based on the stream characterization parameters associated with each of the active applications to allocate bandwidth to the corresponding traffic in both the uplink and downlink directions such that the sum of the bandwidth allocated to the active applications does not exceed the available bandwidth. By examining the stream characterization parameters associated with each of the active applications, the bandwidth control unit 114 can determine how to best throttle and shape the traffic in both the uplink and downlink directions at various instance in time (i.e., from one time slice to another); for example, by delaying packets, delaying acknowledgements, dropping packets, etc. In other words, at each instance of time, the bandwidth control unit 114 can determine how to best combine the different packet streams associated with the different active applications by varying the bandwidth allocated to each of the packet streams in an optimal manner to result in optimal network performance without exceeding the available bandwidth, as will be further described below with reference to blocks 214-216. After block 212, the flow continues at block 214.

At block 214, it is determined whether an optimal bandwidth can be allocated to each packet stream at the router. In some implementations, the bandwidth control unit 114 can read the optimal bandwidth parameter from the stream characterization parameters associated with each packet stream (determined in block 210) and determine whether the optimal bandwidth can be allotted to each of the packet streams based on the available bandwidth in the network. For example, the optimal bandwidth associated with a first packet stream corresponding to a first application may be 4 Mbps, the optimal bandwidth associated with a second packet stream corresponding to a second application may be 2 Mbps, the optimal bandwidth associated with a third packet stream corresponding to a third application may be 2 Mbps, and the optimal bandwidth associated with a fourth packet stream corresponding to a fourth application may be 1 Mbps. If the available bandwidth is 10 Mbps, the bandwidth control unit 114 determines that the optimal bandwidth can be allocated to each of the packet streams because the total amount of bandwidth allocated would not exceed the available bandwidth. If the available bandwidth is 8 Mbps, the bandwidth control unit 114 determines that the optimal bandwidth cannot be allocated to each of the packet streams because the total amount of bandwidth allocated would exceed the available bandwidth. If the bandwidth control unit 114 determines that the optimal bandwidth can be allocated to all the packet streams, the flow continues at block 215. If the bandwidth control unit 114 determines that the optimal bandwidth cannot be allocated to all the packet streams, the flow continues at block 216.

At block 215, the optimal bandwidth is allotted to each of the plurality of packet streams. In some implementations, after the bandwidth control unit 114 determines that the available bandwidth of the network can support the optimal bandwidth requirements of each of the packet streams without exceeding the available bandwidth, the bandwidth control unit 114 allocates the optimal bandwidth to each of the packet streams. After block 215, the flow loops back to block 202 of FIG. 2 to continue to monitor, detect, classify, and allocate bandwidth to the packet streams at the router 110.

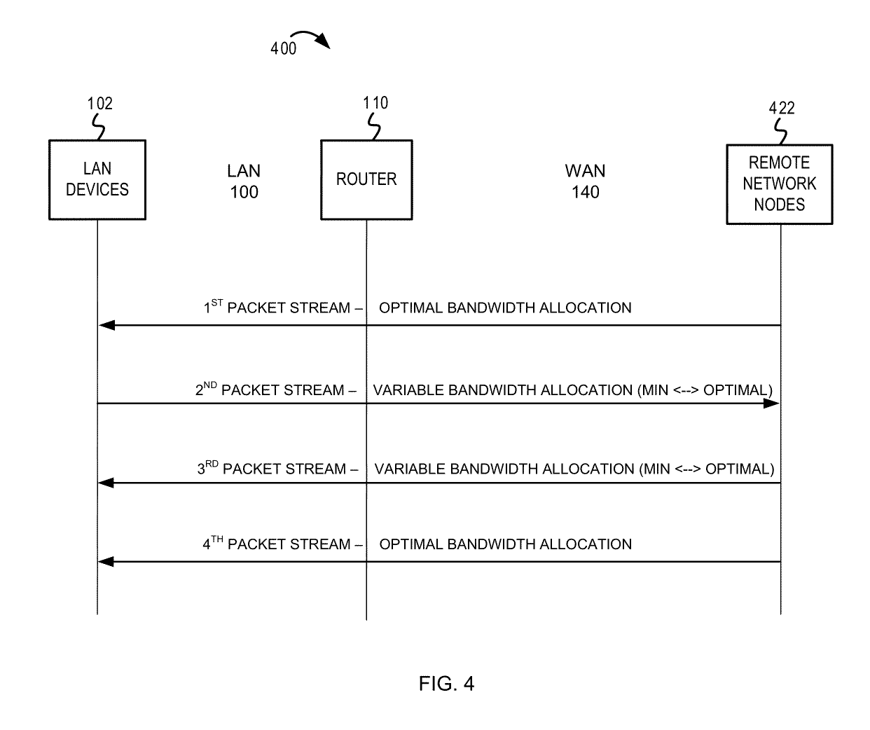

At block 216, in addition to the optimal bandwidth, the remaining stream characterization parameters are analyzed to determine bandwidth allocation for each of the packet streams. In some implementations, in addition to the optimal bandwidth parameter, the bandwidth control unit 114 can analyze one or more of the remaining stream characterization parameters, such as the jitter tolerance value, a minimum bandwidth, a maximum bandwidth, and a priority value. In one example, the bandwidth control unit 114 can consider the jitter tolerance value and the minimum bandwidth associated with each of the packet streams. In another example, the bandwidth control unit 114 can consider all the stream characterization parameters to determine how to allocate the bandwidth without exceeding the available bandwidth. For instance, FIG. 4 illustrates a network diagram including four packet streams that are being routed via the router 110 between the network devices 102 and one or more remote network nodes 422 (see the example described above in the description of block 214). In this example, if the available bandwidth of the network 400 is 8 Mbps and the total optimal bandwidth associated with the four packet streams would equal approximately 9 Mbps, the available bandwidth would be exceeded and therefore the bandwidth control unit 114 can consider one or more additional stream characterization parameters to determine how to allocate the bandwidth. In one implementation, the bandwidth control unit 114 can consider the jitter tolerance value and the minimum bandwidth associated with each of the four packet streams. The bandwidth control unit 114 can determine that the second and third packet streams associated with the second and third applications, respectively, have a high jitter tolerance and a minimum bandwidth of 1 Mbps. In order to allot the available bandwidth to all of the packet streams, the bandwidth control unit 114 can vary the allotted bandwidth of the second and third packet streams between the minimum bandwidth of 1 Mbps and the optimal bandwidth of 2 Mbps at different time instances, since both packet streams are jitter tolerant. Therefore, as shown in the diagram of FIG. 4, the first and fourth packet streams associated with the first and fourth applications, respectively, are allocated an optimal bandwidth associated with each application, and the second and third packet streams associated with the second and third applications, respectively, are allocated a variable bandwidth, which switches between an optimal bandwidth allocation and a minimum bandwidth allocation at different time instances. For example, during a first period of time, the minimum bandwidth can be allocated to the second packet stream and the optimal bandwidth can be allocated to the third packet stream, and during a second period of time, the optimal bandwidth can be allocated to the second packet stream and the minimum bandwidth can be allocated to the third packet stream. This variable bandwidth allocation pattern for the second and third packet streams can repeat or may vary over time. It is noted that various other examples are possible of how to vary the allocation of bandwidth between the second and third packet streams (e.g., depending on additional stream characterization parameters). For example, one of the packet streams (e.g., the second packet stream) may be allocated the optimal bandwidth most or all of the time, and the other packet stream (e.g., the third packet stream) may be allocated the minimum bandwidth most or all of the time. For the packet streams that are allocated a variable bandwidth, the average bandwidth for the packet streams during a period of time will end up somewhere between the minimum bandwidth and the optimal bandwidth. Therefore, allocating a variable bandwidth may result in better performance than just scaling back one or both of the packet streams to the minimum bandwidth. It is further noted that, in some implementations, when a variable bandwidth is allocated between two or more packet streams, the bandwidth control unit 114 can determine to allocate other bandwidth levels in between the minimum and optimal bandwidth levels. For example, the bandwidth control unit 114 can determine that an intermediate bandwidth between the minimum and optimal bandwidths can be allocated if the sum of the allocated bandwidths would not exceed the total available bandwidth. For instance, in the example described above, the second packet stream can be allocated the optimal bandwidth and the third packet stream can be allocated an intermediate bandwidth (between the minimum and optimal bandwidths) if the total available bandwidth would not be exceeded. Similarly, in some cases, both the second and third packet streams can be allocated an intermediate bandwidth (between the minimum and optimal bandwidths) as long as the total available bandwidth is not exceeded. In some implementations, when certain packet streams are allocated an optimal bandwidth, the bandwidth may also vary from time to time (e.g., from one time slice to another), but the average bandwidth the packet stream is allocated over a period of time is the optimal bandwidth.

In another example, if a new application is starting up, and the bandwidth is already allocated to the other packet streams associated with the active applications, the bandwidth control unit 114 may allocate extra bandwidth (e.g., a maximum bandwidth requirement) during a particular period of time to help initiate the new application. In this example, if there are two active applications, the bandwidth associated with the application that is the most jitter tolerant may be scaled back (e.g., to the minimum bandwidth) and this extra bandwidth can be allocated to the new application until the initiation process is completed. In one implementation, when a new application is detected, the bandwidth control unit 114 can determine whether sufficient bandwidth is available (in addition to the bandwidth already allocated to existing applications) in the network to initiate and support the packet stream associated with the new application. If not enough bandwidth is available, the bandwidth control unit 114 can determine which applications to scale back the bandwidth temporarily or permanently based on the stream characterization parameters associated with the existing applications and the stream characterization parameters associated with the new application. For example, as described above, the bandwidth control unit 114 can determine which existing applications are the most jitter tolerant (based on the jitter tolerance parameter) and also determine the minimum bandwidth associated with the jitter tolerant applications. In some examples, in addition to the jitter tolerance and minimum bandwidth parameters, the bandwidth control unit 114 may also consider the priority parameter, and determine which jitter tolerant application to scale back the bandwidth based on the priority and the minimum bandwidth parameters. In yet another example, if there is an active online gaming application and an active video streaming application, based on the stream characterization parameters the bandwidth control unit 114 can determine that the online gaming application is much less jitter tolerant than the video streaming application (e.g., YouTube application). In this situation, even if the video application may have a higher QoS priority (i.e., the priority parameter) in some circumstances than the gaming application, by considering the totality of the situation and all of the parameters, it may be determined that the bandwidth for the gaming application may need to be increased to ensure that no gaming packets are delayed, even though it may temporarily introduce some jitter to the video streaming application. Furthermore, it is noted that by utilizing the stream characterization parameters for bandwidth control, the router 110 does not allocate active applications unnecessary bandwidth beyond the optimal bandwidth (with some exceptions, as noted above); therefore, bandwidth is typically available for other applications to perform optimally (or at least to operate with the minimum bandwidth requirements). Also, by utilizing the stream characterization parameters for bandwidth control, bandwidth is typically available for new applications that may be detected. After block 216, the flow loops back to block 202 of FIG. 2 to continue to monitor, detect, classify, and allocate bandwidth to the packet streams at the router 110.

It should be understood that FIGS. 1-4 and the operations described herein are examples meant to aid in understanding embodiments and should not be used to limit embodiments or limit scope of the claims. Embodiments may perform additional operations, fewer operations, operations in a different order, operations in parallel, and some operations differently.

As will be appreciated by one skilled in the art, aspects of the present inventive subject matter may be embodied as a system, method, or computer program product. Accordingly, aspects of the present inventive subject matter may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

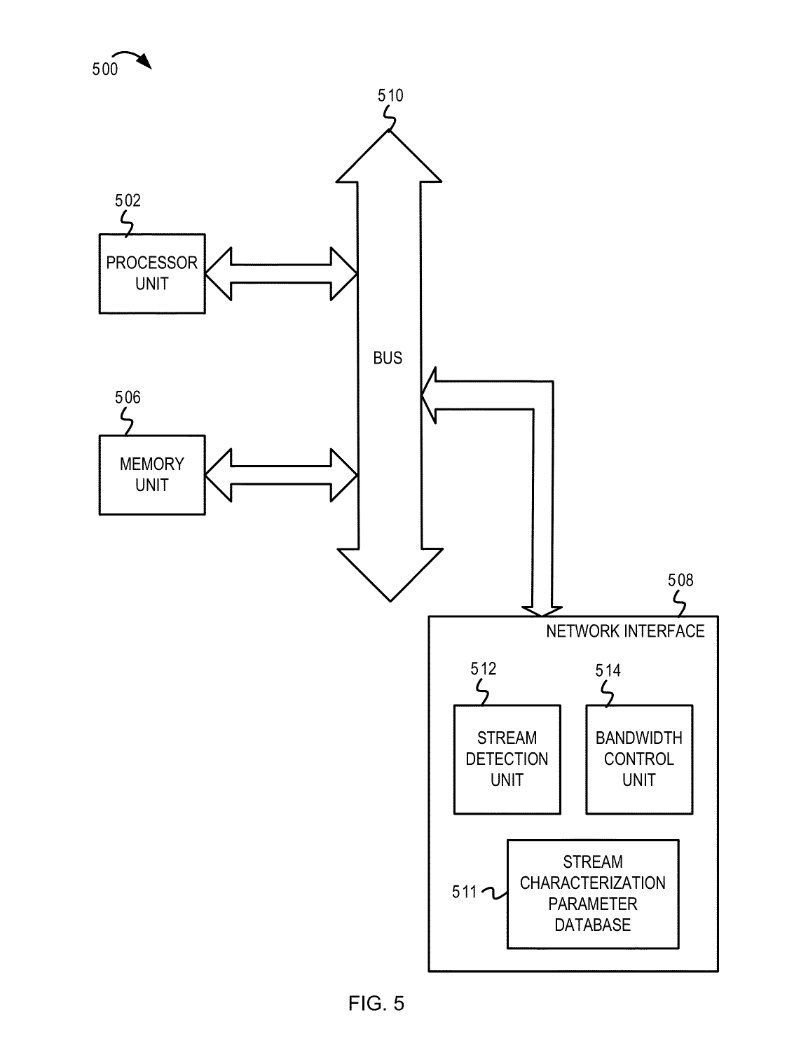

FIG. 5 is a block diagram of one embodiment of a network device 500 including a mechanism for application based bandwidth control in a local area network, according to some embodiments. In some implementations, the network device 500 is a network traffic managing node between two or more networks (e.g., a LAN and a WAN) that receives, processes, and routes packets associated with the networks; for example, the network traffic managing node may be a router/gateway of a LAN (e.g., LAN 100 shown in FIG. 1). It is noted, however, that in other implementations the network device 500 may be other suitable types of network devices that can be configured to implement the functionality described above with reference to FIGS. 1-4, such as a cable modem, a wireless access point, a network bridge, a network switch, a desktop computer, a gaming console, a mobile computing device, etc. The network device 500 includes a processor unit 502 (possibly including multiple processors, multiple cores, multiple nodes, and/or implementing multi-threading, etc.). The network device 500 includes a memory unit 506. The memory unit 506 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable storage media. The network device 500 also includes a bus 510 (e.g., PCI, ISA, PCI-Express, HyperTransport®, InfiniBand®, NuBus, AHB, AXI, etc.), and network interface(s) 508 that include at least one of a wireless network interface (e.g., a Bluetooth interface, a WLAN 802.11 interface, a WiMAX interface, a ZigBee® interface, a Wireless USB interface, etc.) and a wired network interface (e.g., an Ethernet interface, a powerline communication interface, etc.). As illustrated, the network interface(s) 508 also includes a stream detection unit 512, a bandwidth control unit 514, and a stream characterization parameter database 511. For example, the stream detection unit 512, the bandwidth control unit 514, and the stream characterization parameter database 511 may be implemented within a network interface card or network interface module of the network interface(s) 508. The stream detection unit 512, the bandwidth control unit 514, and the stream characterization parameter database 511 may be operable to implement the stream detection and application based bandwidth control mechanism for the network device 500, as describe above with reference to FIGS. 1-4.

Any one of these functionalities may be partially (or entirely) implemented in hardware and/or on the processor unit 502. For example, the functionality may be implemented with one or more application specific integrated circuits, one or more system-on-a-chip (SoC), or other type of integrated circuit(s), in logic implemented in the processor unit 502, in a co-processor on a peripheral device or card, in a separate processor and/or memory implemented within the network interface 508, etc. Further, realizations may include fewer or additional components not illustrated in FIG. 5 (e.g., video cards, audio cards, additional network interfaces, peripheral devices, etc.). The processor unit 502, the memory unit 506, and the network interfaces 508 are coupled to the bus 510. Although illustrated as being coupled to the bus 510, the memory unit 506 may be coupled to the processor unit 502.

While the embodiments are described with reference to various implementations and exploitations, it will be understood that these embodiments are illustrative and that the scope of the inventive subject matter is not limited to them. In general, techniques for implementing a stream detection and an application based bandwidth control mechanism as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
detecting a plurality of packet streams received at a network traffic managing node of a local area network (LAN), the LAN having an available bandwidth;
determining an application associated with each of the plurality of packet streams;
determining stream characterization parameters associated with each application; and
allocating a bandwidth for each of the plurality of packet streams based, at least in part, on the stream characterization parameters associated with each application, wherein a sum of the bandwidth allocated for each of the plurality of packet streams does not exceed the available bandwidth.

2. The method of claim 1, wherein said determining an application associated with each of the plurality of packet streams comprises:
analyzing a plurality of packets associated with each of the plurality of packet streams;
determining a plurality of features associated with the plurality of packets of each of the plurality of packet streams; and
determining the application associated with each of the plurality of packet streams based on the plurality of features associated with the plurality of packets of each of the plurality of packet streams.

3. The method of claim 2, further comprising:
comparing the plurality of features associated with each of the plurality of packet streams to a plurality of predefined packet stream signatures associated with a plurality of known applications; and
determining the application associated with each of the plurality of packet streams based on results of said comparing.

4. The method of claim 3, wherein said comparing comprises, for each of the plurality of packet streams, comparing the plurality of features associated with the packet stream to the plurality of predefined packet stream signatures associated with the plurality of known applications to detect a match within a predefined confidence level.

5. The method of claim 1, further comprising classifying a plurality of packets associated with each of the plurality of packet streams to determine a corresponding application for each of the plurality of packet streams.

6. The method of claim 1, wherein the stream characterization parameters associated with the application include at least one of a jitter tolerance value, a minimum bandwidth, an optimal bandwidth, and a maximum bandwidth.

7. The method of claim 1, wherein said allocating a bandwidth for each of the plurality of packet streams comprises allocating a bandwidth for both uplink and downlink packet streams detected at the network traffic managing node.

8. The method of claim 1, wherein said allocating a bandwidth for each of the plurality of packet streams based, at least in part, on the stream characterization parameters associated with each application comprises:
determining a predefined optimal bandwidth for each application associated with each of the plurality of packet streams based, at least in part, on the stream characterization parameters associated with each application; and
determining whether the predefined optimal bandwidth for each application can be allocated to each of the plurality of packet streams based on whether a sum of the predefined optimal bandwidth for each application associated with each of the plurality of packet streams does not exceed the available bandwidth.

9. The method of claim 8, wherein, in response to determining the sum of the predefined optimal bandwidth for each application associated with each of the plurality of packet streams does exceed the available bandwidth, the method further comprises:
determining one or more additional parameters for each application associated with each of the plurality of packet streams based, at least in part, on the stream characterization parameters associated with each application; and
allocating the bandwidth for each of the plurality of packet streams based, at least in part, on the predefined optimal bandwidth and the one or more additional parameters associated with each application.

10. The method of claim 8, wherein, in response to determining the sum of the predefined optimal bandwidth for each application associated with each of the plurality of packet streams does exceed the available bandwidth, the method further comprises:
determining a predefined jitter tolerance value for each application associated with each of the plurality of packet streams based, at least in part, on the stream characterization parameters associated with each application; and
allocating the bandwidth for each of the plurality of packet streams based, at least in part, on the predefined optimal bandwidth and the predefined jitter tolerance value associated with each application.

11. The method of claim 8, wherein, in response to determining the sum of the predefined optimal bandwidth for each application associated with each of the plurality of packet streams does not exceed the available bandwidth, the method further comprises allocating the predefined optimal bandwidth for each application to each corresponding packet stream.

12. The method of claim 1, wherein, in response to detecting a new packet stream at the network traffic managing node, the method further comprising:
determining an application associated with the new packet stream detected at the network traffic managing node;
identifying a predefined optimal bandwidth and a predefined maximum bandwidth associated with the application associated with the new packet stream based, at least in part, on the stream characterization parameters associated with the application;
allocating the predefined maximum bandwidth to the new packet stream for a period of time; and
determining a bandwidth to allocate to each of a remaining plurality of packet streams for the period of time based, at least in part, on the stream characterization parameters for each application associated with each of the remaining plurality of packet streams.

13. The method of claim 1, further comprising storing a plurality of features associated with a plurality of known applications at the network traffic managing node to determine the application associated with each of the plurality of packet streams detected at the network traffic managing node.

14. The method of claim 13, further comprising, in response to determining an application associated with one of the plurality of packet streams cannot be determined based on a plurality of features associated with the packet stream, determining a packet stream type associated with the packet stream and determining default stream characterization parameters associated with the packet stream type.

15. The method of claim 1, wherein the network traffic managing node comprises a router of the LAN.

16. The method of claim 1, wherein the network traffic managing node comprises a router, an access point, a cable modem, or a network switch of the LAN.

17. A method comprising:
detecting a plurality of packet streams received at a network traffic managing node of a local area network (LAN);
determining an application associated with each of the plurality of packet streams;
determining stream characterization parameters associated with each application;
identifying a predefined optimal bandwidth for each application associated with each of the plurality of packet streams based, at least in part, on the stream characterization parameters associated with each application; and
determining whether the predefined optimal bandwidth for each application can be allocated to each of the plurality of packet streams.

18. The method of claim 17, wherein, in response to determining the predefined optimal bandwidth for each application cannot be allocated to each of the plurality of packet streams, the method further comprises:
determining one or more additional parameters for each application associated with each of the plurality of packet streams based, at least in part, on the stream characterization parameters associated with each application; and
allocating a bandwidth for each of the plurality of packet streams based, at least in part, on the predefined optimal bandwidth and the one or more additional parameters associated with each application.

19. The method of claim 17, wherein, in response to determining the predefined optimal bandwidth for each application cannot be allocated to each of the plurality of packet streams, the method further comprises:
determining a predefined jitter tolerance value for each application associated with each of the plurality of packet streams based, at least in part, on the stream characterization parameters associated with each application; and
allocating a bandwidth for each of the plurality of packet streams based, at least in part, on the predefined optimal bandwidth and the predefined jitter tolerance value associated with each application.

20. The method of claim 17, wherein, in response to determining the predefined optimal bandwidth for each application cannot be allocated to each of the plurality of packet streams, the method further comprises:
determining a predefined jitter tolerance value and a predefined minimum bandwidth for each application associated with each of the plurality of packet streams based, at least in part, on the stream characterization parameters associated with each application; and
allocating a bandwidth for each of the plurality of packet streams based, at least in part, on the predefined optimal bandwidth, the predefined jitter tolerance value, and the predefined minimum bandwidth associated with each application.

21. The method of claim 17, wherein, in response to determining the predefined optimal bandwidth for each application can be allocated to each of the plurality of packet streams, the method further comprises allocating the predefined optimal bandwidth for each application to each corresponding packet stream.

22. A network traffic managing device comprising:
a processor;
a stream detection unit coupled with the processor and configured to:
detect a plurality of packet streams received at a network traffic managing device of a local area network (LAN), the LAN having an available bandwidth;
determine an application associated with each of the plurality of packet streams; and
a bandwidth control unit coupled with the processor and configured to:
determine stream characterization parameters associated with each application, and
allocate a bandwidth for each of the plurality of packet streams based, at least in part, on the stream characterization parameters associated with each application, wherein a sum of the bandwidth allocated for each of the plurality of packet streams does not exceed the available bandwidth.

23. The network traffic managing device of claim 22, wherein the stream detection unit configured to determine an application associated with each of the plurality of packet streams comprises the stream detection unit configured to:
analyze a plurality of packets associated with each of the plurality of packet streams;
determine a plurality of features associated with the plurality of packets of each of the plurality of packet streams; and
determine the application associated with each of the plurality of packet streams based on the plurality of features associated with the plurality of packets of each of the plurality of packet streams.

24. The network traffic managing device of claim 23, wherein the stream detection unit is further configured to:
compare the plurality of features associated with each of the plurality of packet streams to a plurality of predefined packet stream signatures associated with a plurality of known applications; and
determine the application associated with each of the plurality of packet streams based on results of the stream detection unit comparing the plurality of features associated with each of the plurality of packet streams to the plurality of predefined packet stream signatures.

25. The network traffic managing device of claim 24, wherein the stream detection unit configured to compare the plurality of features associated with each of the plurality of packet streams to the plurality of predefined packet stream signatures comprises the stream detection unit configured to, for each of the plurality of packet streams, compare the plurality of features associated with the packet stream to the plurality of predefined packet stream signatures associated with the plurality of known applications to detect a match within a predefined confidence level.

26. The network traffic managing device of claim 22, wherein the stream detection unit is further configured to classify the plurality of packets associated with each of the plurality of packet streams to determine a corresponding application for each of the plurality of packet streams.

27. The network traffic managing device of claim 22, wherein the stream characterization parameters associated with the application includes at least one of a jitter tolerance value, a minimum bandwidth, an optimal bandwidth, and a maximum bandwidth.

28. The network traffic managing device of claim 22, wherein the bandwidth control unit configured to allocate a bandwidth for each of the plurality of packet streams based, at least in part, on the stream characterization parameters associated with each application comprises the bandwidth control unit further configured to:
determine a predefined optimal bandwidth for each application associated with each of the plurality of packet streams based, at least in part, on the stream characterization parameters associated with each application; and
determine whether the predefined optimal bandwidth for each application can be allocated to each of the plurality of packet streams based on whether a sum of the predefined optimal bandwidth for each application associated with each of the plurality of packet streams does not exceed the available bandwidth.

29. The network traffic managing device of claim 28, wherein, in response to the bandwidth control unit determining the sum of the predefined optimal bandwidth for each application associated with each of the plurality of packet streams does exceed the available bandwidth, the bandwidth control unit is further configured to:
determining one or more additional parameters for each application associated with each of the plurality of packet streams based, at least in part, on the stream characterization parameters associated with each application; and
allocating the bandwidth for each of the plurality of packet streams based, at least in part, on the predefined optimal bandwidth and the one or more additional parameters associated with each application.

30. The network traffic managing device of claim 28, wherein, in response to the bandwidth control unit determining the sum of the predefined optimal bandwidth for each application associated with each of the plurality of packet streams does exceed the available bandwidth, the bandwidth control unit is further configured to:
determine a predefined jitter tolerance value for each application associated with each of the plurality of packet streams based, at least in part, on the stream characterization parameters associated with each application; and
allocate the bandwidth for each of the plurality of packet streams based, at least in part, on the predefined optimal bandwidth and the predefined jitter tolerance value associated with each application.

31. The network traffic managing device of claim 22, wherein, in response to the bandwidth control unit determining the sum of the predefined optimal bandwidth for each application associated with each of the plurality of packet streams does not exceed the available bandwidth, the bandwidth control unit is further configured to allocate the predefined optimal bandwidth for each application to each corresponding packet stream.

32. The network traffic managing device of claim 22, wherein, in response to detecting a new packet stream at the network traffic managing device, the bandwidth control unit is further configured to:
determine an application associated with the new packet stream detected at the network traffic managing device;
identify a predefined optimal bandwidth and a predefined maximum bandwidth associated with the application associated with the new packet stream based, at least in part, on the stream characterization parameters associated with the application;
allocate the predefined maximum bandwidth to the new packet stream for a period of time; and
determine a bandwidth to allocate to each of a remaining plurality of packet streams for the period of time based, at least in part, on the stream characterization parameters for each application associated with each of the remaining plurality of packet streams.

33. The network traffic managing device of claim 22, wherein the network traffic managing device comprises a router of the local area network.

34. The network traffic managing device of claim 22, wherein the network traffic managing device comprises a router, an access point, a cable modem, or a network switch of the local area network.

35. A network router comprising:
a processor; and
a memory unit configured to store instructions which, when executed by the processor, causes the network router to perform operations that comprise:
detecting a plurality of packet streams received at the network router;
determining an application associated with each of the plurality of packet streams;
determining stream characterization parameters associated with each application;
identifying a predefined optimal bandwidth for each application associated with each of the plurality of packet streams based, at least in part, on the stream characterization parameters associated with each application; and
determining whether the predefined optimal bandwidth for each application can be allocated to each of the plurality of packet streams.

36. The network router of claim 35, wherein the instructions executed by the processor causes the network router to perform operations that further comprise:
analyzing a plurality of packets associated with each of the plurality of packet streams;
determining a plurality of features associated with the plurality of packets of each of the plurality of packet streams; and
determining the application associated with each of the plurality of packet streams based on the plurality of features associated with the plurality of packets of each of the plurality of packet streams.

37. The network router of claim 36, wherein the instructions executed by the processor causes the network router to perform operations that further comprise:
comparing the plurality of features associated with each of the plurality of packet streams to a plurality of predefined packet stream signatures associated with a plurality of known applications; and
determining the application associated with each of the plurality of packet streams based on results of said comparing.

38. The network router of claim 35, wherein, in response to determining the predefined optimal bandwidth for each application cannot be allocated to each of the plurality of packet streams, the instructions executed by the processor causes the network router to perform operations that further comprise:
determining one or more additional parameters for each application associated with each of the plurality of packet streams based, at least in part, on the stream characterization parameters associated with each application; and
allocating a bandwidth for each of the plurality of packet streams based, at least in part, on the predefined optimal bandwidth and the one or more additional parameters associated with each application.

39. The network router of claim 35, wherein, in response to determining the predefined optimal bandwidth for each application cannot be allocated to each of the plurality of packet streams, the instructions executed by the processor causes the network router to perform operations that further comprise:
determining a predefined jitter tolerance value for each application associated with each of the plurality of packet streams based, at least in part, on the stream characterization parameters associated with each application; and
allocating a bandwidth for each of the plurality of packet streams based, at least in part, on the predefined optimal bandwidth and the predefined jitter tolerance value associated with each application.

40. One or more machine-readable storage media having stored therein instructions, which when executed by one or more processors causes the one or more processors to perform operations that comprise:
detecting a plurality of packet streams of a local area network;
determining an application associated with each of the plurality of packet streams;
determining stream characterization parameters associated with each application;
identifying a predefined optimal bandwidth for each application associated with each of the plurality of packet streams based, at least in part, on the stream characterization parameters associated with each application; and
determining whether the predefined optimal bandwidth for each application can be allocated to each of the plurality of packet streams.

41. The machine-readable storage media of claim 40, wherein said operation of determining an application associated with each of the plurality of packet streams comprises:
analyzing a plurality of packets associated with each of the plurality of packet streams;
determining a plurality of features associated with the plurality of packets of each of the plurality of packet streams; and
determining the application associated with each of the plurality of packet streams based on the plurality of features associated with the plurality of packets of each of the plurality of packet streams.

42. The machine-readable storage media of claim 40, wherein, in response to determining the predefined optimal bandwidth for each application cannot be allocated to each of the plurality of packet streams, the operations further comprise:
determining one or more additional parameters for each application associated with each of the plurality of packet streams based, at least in part, on the stream characterization parameters associated with each application; and
allocating a bandwidth for each of the plurality of packet streams based, at least in part, on the predefined optimal bandwidth and the one or more additional parameters associated with each application.
